(19) United States
(12) Patent Application Publication
(10) Pub. No.: US 2014/0300712 A1
(43) Pub. Date: Oct. 9, 2014

(54) TRI-VIEWING ANGLE DISPLAY

(71) Applicant: BOE TECHNOLOGY GROUP CO., LTD., Beijing (CN)

(72) Inventors: Xiaofeng Ma, Beijing (CN); Jaegeon You, Beijing (CN)

(21) Appl. No.: 14/126,924

(22) PCT Filed: Dec. 7, 2012
(86) PCT No.: PCT/CN2012/086225

§ 371 Date: Dec. 17, 2013

(30) Foreign Application Priority Data
Jul. 20, 2012 (CN) 201210254432.6

(51) Int. Cl. H04N 13/04

(52) U.S. Cl. CPC H04N 13/0447; H04N 13/0409; H04N 2213/001
USPC 348/54

(57) ABSTRACT

A tri-viewing angle display comprises a display panel and a parallax barrier located in front of the display panel, the parallax barrier comprises light transmitting strips and light shielding strips that are arranged alternately and parallel to each other, and the display panel is provided with three pixel areas arranged successively and periodically thereon, each of the light shielding strips is positioned right above two adjacent pixel areas and a width of the light shielding strip is greater than the sum of widths of the two adjacent pixel areas. Provision of three sets of image presentation areas on the display panel increases contents that can be simultaneously displayed by the liquid crystal display, and improves the displaying efficiency of the display; further, viewers in all the watching zones can watch the images displayed in the corresponding image presentation area, without being interfered by the images displayed in other image presentation areas, thus increasing the areas of visual regions and improving display quality.

### TECHNICAL FIELD

The embodiment of the present invention relates to a tri-viewing angle display.

### BACKGROUND

As flat panel displays are gradually used extensively, a kind of bi-viewing angle displays are brought out in the art of state, in which a layer of parallax barrier is added in front of an ordinary display panel to achieve bi-vision display. FIG. 1 is a schematic view illustrating the image display of a bi-viewing angle liquid crystal display in the art of state. This bi-viewing angle liquid crystal display mainly comprises a display panel 11 and a parallax barrier 12 provided over the display panel 11, the parallax barrier 12 is composed of the light transmitting strips and the light shielding strips arranged alternately and is a kind of optical devices like a slit grating. The specific principle for such a bi-viewing angle liquid crystal display is: the viewers in the left vision zone B can, through the light transmitting strips of the parallax barrier 12, watch the pixels in the left vision pixel area 2 of the display panel 11; and the viewers in the right vision zone B at the right side of the display panel 11 can, through the light transmitting strips of the parallax barrier 12, watch the pixels in the right vision pixel area 3 of the display panel 11. The left vision pixel area 2 and the right vision pixel area 3 can be input with different images therein, respectively, to display different contents, thereby achieving the effect of bi-viewing angle.

The above bi-viewing angle liquid crystal display comprises two vision zones, i.e., the left and right vision zones, the viewers in these two vision zones can watch the corresponding display content on the liquid crystal display panel 11. However, the main vision zone A is formed right in front of the display panel 11, when a viewer watches the display panel 11 in this zone, due to part of the left vision pixel area 2 and part of the right vision pixel area 3 are blocked by the light transmitting strips of the parallax barrier 12, the viewer can watch two sets of display contents simultaneously, and thus the main vision zone A is turned into a vertigo zone, thereby reducing the viewing angle of the display panel 11 and thus narrowing the viewable zones, depressing the displaying efficiency.

### SUMMARY

The embodiments of the present invention provide a tri-viewing angle display capable of widening the viewing angle and displaying efficiency of the display panel.

An embodiment of the present invention provides a tri-viewing angle display, which comprises a display panel and a parallax barrier located in front of the display panel, the parallax barrier comprises light transmitting strips and light shielding strips arranged alternately and parallel to each other, the display panel is provided with three pixel areas successively and periodically arranged thereon, each of the light shielding strips is positioned right above two adjacent pixel areas of the three pixel areas, and a width of the light shielding strip is greater than the sum of widths of the two adjacent pixel areas, each of the light transmitting strips is arranged right above one of the three pixel areas other than the two adjacent pixel areas.

In an embodiment, a distance H between the parallax barrier and the display panel may range from 1 μm to 200 μm. In an embodiment, widths L of the three pixel areas may be equal to each other, L ranges from 20 μm to 500 μm, and a width of the light transmitting strip is less than L. In an embodiment, a width 1 of the light transmitting strip may satisfy 100 μm≦1≦(L−5) μm, wherein 100 μm≦1≦200 μm, 20 μm≦H≦120 μm.

In an embodiment, the widths of the three pixel areas may be not all equal to each other, and each of the widths is within a numeric range between 20 μm and 500 μm.

In an embodiment, the width l of the light transmitting strip meets: 100 μm≦1≦(L1−5) μm, L1 is a width of the pixel area located right below the light transmitting strip, satisfying 100 μm≦L1≦200 μm, and 20 μm≦H≦120 μm.

In the embodiment, widths, by which both ends of the light shielding strip in the width direction extend beyond the edges of the adjacent two pixel areas, may be equal to each other.

In an embodiment, each of the three pixel areas may comprise a black matrix for separating the image presentation areas in different pixel areas from each other.

In an embodiment, the tri-viewing angle display may be a liquid crystal display, an OLED display or an electronic paper display.

In the tri-viewing angle display provided by the embodiment of the present invention, three sets of image presentation areas are provided on the display panel, thereby increasing contents that can be simultaneously displayed by the liquid crystal display, and improving the displaying efficiency of the display; and further, the parallax barrier is used to divide the watching zone of the display into a left and right vision zones and a main vision zone right in front of the display, thus it's possible for viewers in every watching zones to watch the images displayed in the corresponding image presentation area, without being interfered by the images displayed in other image presentation areas, thus increasing the areas for visual regions and improving display quality.

### BRIEF DESCRIPTION OF THE DRAWINGS

In order to illustrate the technical solution of the embodiment of the present invention more clearly, a simply introduction about the drawings of the embodiments will be made in the following, and obviously, the drawings described later relate to only some embodiments of the present invention, rather than limitation to the present invention.

FIG. 1 is a schematic view illustrating the image display of a bi-viewing angle liquid crystal display in the art of state;

FIG. 2 is a schematic view illustrating image display of the tri-viewing angle liquid crystal display according to the first embodiment of the present invention; and

FIG. 3 is a schematic view illustrating the light path for image display of a tri-viewing angle liquid crystal display according to the second embodiment of the present invention.

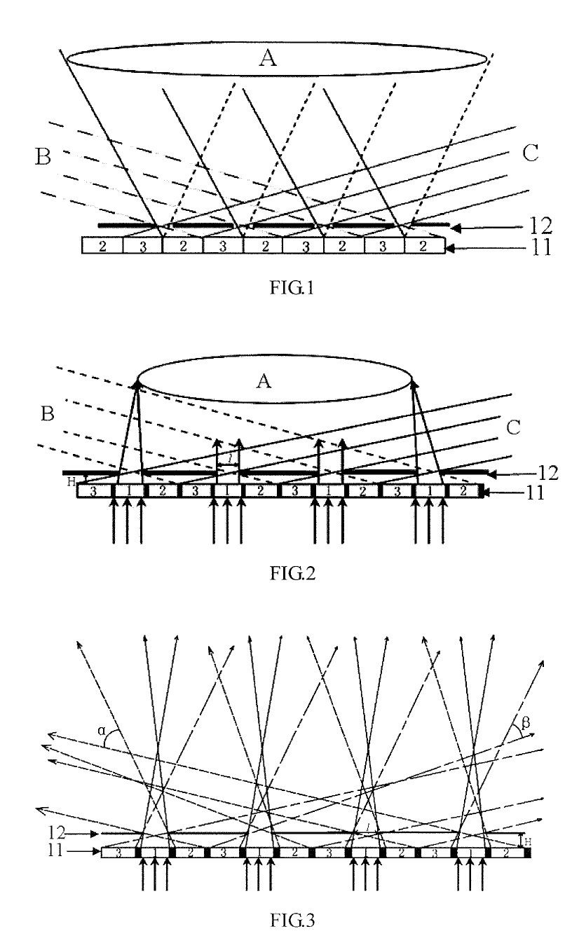

### DETAILED DESCRIPTION

To make clearer the object, technical solutions and advantages of the embodiments of the present invention, a clear and full description of the technical solution of the embodiment of the present invention will be made with reference to the accompanying drawings of the embodiment of the present invention. Obviously, the described embodiments are merely part of the embodiments of the present invention, but not all the embodiments. Based on the described embodiments of the present invention, all the other embodiments acquired by the ordinary skilled in this art, without any creative labor, fall into the protective scope of the present invention.

### Embodiment 1

FIG. 2 is a schematic view illustrating the image display of a tri-viewing angle liquid crystal display according to the first embodiment, this tri-viewing angle liquid crystal display may comprise a liquid crystal display panel 11 and a parallax barrier 12 located in front of the liquid crystal display panel 11. The liquid crystal display panel 11 may be provided with three pixel areas thereon arranged periodically, which are defined as a main vision pixel area 1, a left vision pixel area 2 and a right vision pixel area 3 respectively. The main vision pixel area 1 is an image zone of the liquid crystal display panel 11 which can be watched by a viewer right in front of the liquid crystal display panel 11. The left vision pixel area 2 is an image zone of the liquid crystal display panel 11 which can be watched by the viewer in the left watching zone, by taking the paper surface as a reference. The right vision pixel area 3 is an image zone of the liquid crystal display panel 11 which can be watched by the viewer in the right watching zone, by taking the paper surface as a reference. Each of the three pixel areas may comprise an image presentation area and a black matrix for separating the image presentation areas in different pixel areas from each other. The parallax barrier 12 may comprise light transmitting strips and light shielding strips that are arranged alternately and parallel to each other, the light shielding strips may be located right above optional adjacent left vision pixel area 2 and right vision pixel area 3, and the width of the light shielding strip is greater than the sum of the widths of the adjacent left vision pixel area 2 and right vision pixel area 3, and further, the widths, by which both ends of the light shielding strip in the width direction extend beyond the edges of the left vision pixel area 2 and the right vision pixel area 3, may be equal to each other. Correspondingly, the light transmitting strips may be located right above the main vision pixel area 1, and the width of the light transmitting strip is less than that of the main vision pixel area 1, and further, the distances from both ends of the light transmitting strip in the width direction to the edges at both sides of the main vision pixel area 1 may be equal to each other.

It should be noted that the aforesaid liquid crystal panel 11 may also be replace with an organic light-emitting diode (OLED) display panel or an electronic paper display panel and the like.

According to the above structural arrangement, due to the light shielding strip is located right above optional adjacent left vision pixel area 2 and right vision pixel area 3, thereby when a viewer is watching right in front of the liquid crystal display panel 11, the light shielding strip shields the image presentation areas of the left vision pixel area 2 and the right vision pixel area 3 from the viewer, such that the viewers, situated at the main vision zone A right in front of the liquid crystal display panel 11, can only watch the images presented in the main vision pixel area 1 while the images presented in the left vision pixel area 2 and the right vision pixel area 3 are invisible, the viewers will not be affected by the images presented in the left vision pixel area 2 and the right vision pixel area 3 and thus the occurrence of vertigo can be avoided. Because of the width of the light transmitting strip is less than the width of the main vision pixel area 1, when the viewer at the left or right watching zone, taking the paper surface as a reference, watches the liquid crystal display panel 11, the light emitted from the liquid crystal display panel 11 enters into human eyes obliquely through the transmitting zone; in a certain angle region, for example in the left vision zone B illustrated in FIG. 2, it can be achieved for the light shielding strip to shield the images presented by both the main vision pixel area 1 and the right vision pixel area 3, while only the image presented in the left vision pixel area 2 is visible; or, in another angle region, for example in the right vision zone C illustrated in FIG. 2, it can be achieved for the light shielding strip to shield the images presented by both the main vision pixel area 1 and the left vision pixel area 2, while only the image presented in the right vision pixel area 3 is visible. When identical image signals are input into the left vision pixel area 2 and the right vision pixel area 3, the viewers at the left vision zone B and the right vision zone C can watch identical images; and when different image signals are input into the left vision pixel area 2 and the right vision pixel area 3, the viewers at the left vision zone B and the right vision zone C can watch different images. If required in practice, the main vision pixel area 1, the left vision pixel area 2 and the right vision pixel area 3 can be provided with respective image signals so as to satisfy requirements of the viewers in different zones. The left vision zone B is the watching zone where only the images presented in the left vision pixel area 2 are visible, and the right vision zone C is the watching zone where only the images presented in the right vision pixel area 3 are visible.

In this embodiment, in order to control the thickness of the liquid crystal display, the distance between the liquid crystal display panel 11 and the parallax barrier 12 may be set in a range of 1 nm to 200 nm; by controlling the magnitudes of the distance H and the width of the light transmitting strip, it's possible to adjust the magnitudes of the main viewing angle and the left and right viewing angles. In FIG. 2, the widths of the main vision pixel area 1, the left vision pixel area 2 and the right vision pixel area 3 are equal to each other, this width is indicated as ‘L’, where L is in a range from 20 nm to 500 μm, to achieve continuity for the image display. The width of the light transmitting strip is indicated as ‘l’, and ‘α’ is the left viewing angle, that is, the angle region for watching in which only the images presented within the left vision pixel area 2 can be visible, and ‘β’ is the right viewing angle, that is, the angle region for watching in which only the images presented within the right vision pixel area 3 can be visible. As illustrated in FIG. 3, based on the schematic view of the light path for image display in FIG. 3, it can known that α=β=arctg(H/(L−1))−arctg(H/(L+1)), and further, α and β are in a range of 8°-82° in consideration of the numeric range of H and L. For example, when H=200 nm, L=20 μm, and l=15 μm, α and β are 8°; when H=69 μm, L=500 nm, and l=495 μm, α and β are 82°; when H=96 μm, L=100 nm, and l=95 μm, α and β are 60°; and when H=1 μm, L=20 nm, and l=15 nm, α and β are 9.7°.

In order to enlarge the view angle region for the left vision zone B and the right vision zone C, preferably, the value of H is set in a range of 20 μm-120 nm, the value of L is in a range of 100 nm-200 nm, and 100 nm≦1≦(L−5) μm, in this case better left and right view angle regions can be obtained, α, ≢ are approximately between 55° to 78°, and in this view angle region, the display has better brightness. The specific conditions for obtaining the above left, right view angle region comprise: when H=115 μm, L=190 nm, and l=155 μm, both α and β are 55°; when H=44 μm, L=200 nm, and l=195 μm, α and β are 78°; and when H=60 μm, L=160 nm, and l=150 nm, α and β are 70°.

### Embodiment 2

The tri-viewing angle liquid crystal display according to the second embodiment is same as the first embodiment in their principles, with a configuration similar to that of the display of the first embodiment, except that the widths of the main vision pixel area 1, the left vision pixel area 2 and the right vision pixel area 3 are not all equal to each other; here the wording “not all equal” means that at least two of the widths of the main vision pixel area 1, the left vision pixel area 2 and the right vision pixel area 3 are not the same. The width of the main vision pixel area is L1, the width of the left vision pixel area 2 is L2, and the width of the right vision pixel area 3 is L3, the numeric range for L1, L2 and L3 each may be from 20 μm to 500 μm. A light transmitting strip may be located right above the main vision pixel area 1, and in order to prevent the images presented in the left vision pixel area 2 and the right vision pixel area 3 from causing vertigo to the viewer, the width of the light transmitting strip may be set to be less than L1. The left vision pixel area 2 and the right vision pixel area 3 may be located right below the light shielding strip, and the width of the light shielding strip may be greater than the sum L2+L3 of the widths of the left vision pixel area 2 and the right vision pixel area 3.

According to the principle for the light path as illustrated in FIG. 3, the left viewing angle α and the right viewing angle β are α=arctg(H/(L1-1))−arctg(H/(L2+1)) and β=arctg(H/(L1−1))'arctg(H/(L3+1)), respectively. According to the numeric range for H, L1, L2 and L3, the numeric range for α and β may be from 8° to 82°. For example, when H=5 μm, L1=35 μm, L2=40 μm, L3=45 μm, and l=15 μm, α is 8.8°, and β is 8°; or, for example, when H=5 μm, L1=35 μm, L2=45 μm, L3=40 μm, and l=15 μm, α is 8° and β is 8.8°. When H=65 μm, L1=495 μm, L2=490 μm, L3=400 μm, and l=490 μm, α is 82°, β is 81°; or, for example, when H=85 μm, L1=495 μm, L2=400 μm, L3=490 μm, and l=490μm, α is 81°, and β is 82°. When H=45 μm, L1=200 μm, L2=190 μm, L3=160 μm, and l=180, α is 59°, and β is 58°; or, for example, when H=77 μm, L1=200 μm, L2=160 μm, L3=190 μm, and l=180 μm, α is 63°, and β is 64°.

In order to enlarge the view angle region for the left vision zone B and the right vision zone C, preferably, the value of H is set in a range of 20 μm-120 μm, the value of L1 is in a range of 100 μm-200 μm, and 100 μm≦1≦(L1−5) μm, in this case better left and right view angle regions can be obtained, α, β are approximately between 55° to 78°, and in this view angle region, the display has better brightness. For example, when H=50 μm, L1=190 μm, L2=170 μm, L3=185 μm, and l=165 μm, a is 55°, and β is 55.3°; or, for example, when H=50 μm, L1=190 μm, L2=185 μm, L3=170 μm, and l=165 μm, α is 55.3°, and β is 55°. For example, when H=45 μm, L1=200μm, L2=190 μm, L3=195 μm, α and l=195 μm, α is 77°, and β is 77°; or, for example, when H=50 μm, L1=200 μm, L2=195 μm, L3=190 μm, and l=190 μm, α is 77°, and β is 77°. For example, when H=200 μm, L1=180 μm, L2=180 μm, L3=160 μm, and l=160 μm, α is 54°, and is 54°; or, for example, when H=200 μm, L1=180 μm, L2=160 μm, L3=180 μm, and l=160 μm, α is 52°, and β is 54°.

Although the tri-viewing angle display is illustrated by taking the liquid crystal display as an example in the above embodiments, the tri-viewing angle display may also be an OLED display, an electronic paper display or other types of display.

It can be observed from the above embodiments that, the embodiments of the present invention, by providing three sets of image presentation areas on the display panel, increase contents that can be simultaneously presented by the liquid crystal display, and improve the displaying efficiency of the display; and further, the parallax barrier is used to divide the watching zone of the display into the left and right vision zones as well as a main vision zone right in front of the display, thus it's possible for viewers in every watching zones to watch the images displayed in the corresponding image presentation areas, without being interfered by the images displayed in other image presentation areas, thus increasing the areas for visual regions and improving display quality.

The above described are solely exemplary embodiments of the present invention, rather than limitation on the protective scope of the present invention which is defined by the attached claims.

1. A tri-viewing angle display comprising a display panel and a parallax barrier located in front of the display panel , the parallax barrier comprising light transmitting strips and light shielding strips that are arranged alternately and parallel to each other,
wherein the display panel is provided with three pixel areas successively and periodically arranged thereon, each of the light shielding strips is located right above two adjacent pixel areas of the three pixel areas, and
wherein a width of the light shielding strip is greater than the sum of widths of the two adjacent pixel areas, and each of the light transmitting strips is located right above the one pixel area of the three pixel areas other than the two adjacent pixel areas.

2. The tri-viewing angle display according to claim 1, wherein a distance H between the parallax barrier and the display panel ranges from 1 μm to 200 μm.

3. The tri-viewing angle display according to claim 1, wherein widths L of the three pixel areas are equal to each other, where L is in a range from 20 μm to 500 μm, and a width of the light transmitting strip is less than L.

4. The tri-viewing angle display according to claim 3, wherein the width l of the light transmitting strip meets 100 μm≦l≦(L−5) μm,
where 100 μm≦L≦200 μm, and the distance H between the parallax barrier and the display panel meets 20 μm≦H≦120 μm.

5. The tri-viewing angle display according to claim 1, wherein widths of the three pixel areas are not all equal to each other, and each of the widths is within a numeric range between 20 μm and 500 μm.

6. The tri-viewing angle display according to claim 5, wherein a width l of the light transmitting strip meets 100 μm≦l≦(L1−5) μm,
where L1 is a width of the pixel area located right below the light transmitting strip, satisfying 100 μm≦L1≦200 μm, and the distance H between the parallax barrier and the display panel meets 20 μm≦H≦120 μm.

7. The tri-viewing angle display according to claim 1, wherein widths, by which both ends of the light shielding strip in the width direction extend beyond the edges of the adjacent two pixel areas, are equal to each other.

8. The tri-viewing angle display according to claim 1, wherein each of the three pixel areas comprises a black matrix for separating the image presentation areas in different pixel areas from each other.

9. The tri-viewing angle display according to claim 1, wherein the tri-viewing angle display is a liquid crystal display, an OLED display or an electronic paper display.
